(19) United States
(12) Patent Application Publication
(10) Pub. No.: US 2025/0269913 A1
(43) Pub. Date: Aug. 28, 2025

(54) ADJUSTABLE REAR SPOILER

(71) Applicant: TOYOTA JIDOSHA KABUSHIKI KAISHA, Aichi-ken (JP)

(72) Inventor: Fukunori MIYAUCHI, Toyoake-shi (JP)

(21) Appl. No.: 19/055,498

(22) Filed: Feb. 18, 2025

(30) Foreign Application Priority Data
Feb. 22, 2024 (JP) 2024-025052

(51) Int. Cl. B62D 35/00

(52) U.S. Cl. CPC B62D 35/007

(57) ABSTRACT

An adjustable rear spoiler comprises a rear wing which extends above a vehicle body along a vehicle width direction, a support plate disposed at both ends of the rear wing to support the rear wing such that the rear wing is rotatable about a rotation axis that extends in the vehicle width direction, an electric motor disposed below each of the support plates, a link extending in a vertical direction, an upper end of the link connected to an end of the rear wing; and, a lifting mechanism which moves the link up and down by rotating a rotor of the electric motor.

### CROSS REFERENCE TO RELATED APPLICATION

This application claims priority to Japanese Patent Application No. 2024-025052 filed on Feb. 22, 2024, which is incorporated herein by reference in its entirety including the specification, claims, drawings, and abstract.

### TECHNICAL FIELD

The present disclosure relates to an adjustable rear spoiler for a vehicle.

### BACKGROUND

JP H07-002148 A discloses an adjustable rear spoiler in which an electric motor and a link mechanism located near a rear wing can raise and lower the rear wing.

When a vehicle is traveling at high speed, a large amount of force is applied to the rear wing, so it takes a considerable amount of force to move the rear wing while traveling at high speed. For this reason, an adjustable rear spoiler requires an electric motor that is large in size and weight, and capable of generating a suitable amount of torque, in order to move the rear wing.

However, when an electric motor or link mechanism with a large size and weight is placed near the rear wing, as in the adjustable rear spoiler disclosed in JP H07-002148 A, the center of gravity of the vehicle equipped with the adjustable rear spoiler will increase, and the value of the drag coefficient (CD) will worsen.

Given the above circumstances, an advantageous effect of the present disclosure is to provide the adjustable rear spoiler that can achieve a reduction in the center of gravity of a vehicle and an improvement in the CD value.

### SUMMARY

According to an aspect of the present disclosure, an adjustable rear spoiler comprises a rear wing which extends above a vehicle body along a vehicle width direction, a support plate disposed at both ends of the rear wing to support the rear wing such that the rear wing is rotatable about a rotation axis that extends in the vehicle width direction, an electric motor disposed below each of the support plates, and a link mechanism disposed at both ends of the rear wing. Each link mechanism comprises an electric motor disposed below each of the support plates and a lifting mechanism which moves the link up and down by rotating a rotor of the electric motor. The link mechanism allows the rear wing to be rotated about the rotation axis by moving the link up and down by rotating the rotor. The electric motors and the lifting mechanisms are arranged inside the vehicle body.

This disclosure provides an adjustable rear spoiler that can lower the center of gravity of a vehicle and improve the CD value.

According to an aspect of this disclosure, the adjustable rear spoiler may include a tubular support which extends downward from each of the support plates, and a base plate attached to each of the tubular supports, the electric motor fixed on one surface of the base plate and a lifting mechanism attached to the other surface. The tubular support may have a through hole which allows the lifting mechanism to be inserted into the tubular support. The electric motor may be fixed on an outer side of the tubular support by fixing the base plate to the tubular support with the lifting mechanism having been inserted into the tubular support through the through hole such that the base plate blocks the through hole and reinforces the tubular support.

According to this method, the strength of the tubular support with the through hole formed for the lifting mechanism can be improved.

According to an aspect of this disclosure, in the adjustable rear spoiler, the upper end of the link may be connected to the end of the rear wing via a socket of a screw-in type, and the socket can be moved upward and downward by rotating the socket.

According to this method, the vertical misalignment of the rear wing caused by variations in the link mechanism can be reduced.

According to an aspect of this disclosure, the adjustable rear spoiler may include a biasing element which exerts a force in a direction of pushing the link upward or pulling the link downward.

According to this method, the rear wing can be prevented from swaying up and down due to the effects of the wind while the vehicle is in motion.

The present disclosure can provide the adjustable rear spoiler that can lower the center of gravity of a vehicle and improve the CD value.

### BRIEF DESCRIPTION OF DRAWINGS

Embodiments of the present disclosure will be described based on the following figures, wherein:

FIG. 1 is an oblique view of an adjustable rear spoiler according to the embodiment;

FIG. 2 is a side view showing the front of the rear wing lowered;

FIG. 3 is a side view showing the front of the rear wing raised;

FIG. 4 is an oblique view of the link mechanism of the adjustable rear spoiler according to the embodiment;

FIG. 5 is an oblique view that shows an enlarged version of the lifting mechanism of the link mechanism shown in FIG. 4; and

FIG. 6 shows a through hole formed in a tubular support of an adjustable rear spoiler of the embodiment.

### DESCRIPTION OF EMBODIMENTS

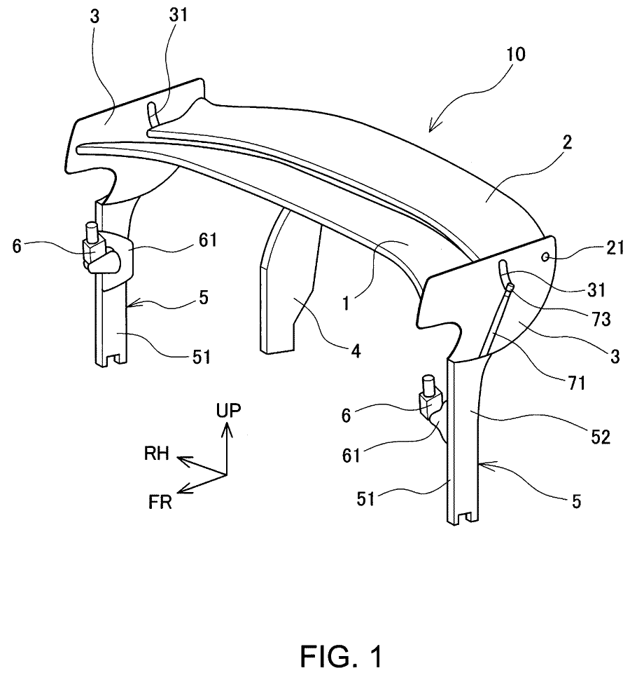

The following describes the adjustable rear spoiler 10 of the embodiment according to the present disclosure, with reference to FIGS. 1 to 6. Arrows FR, UP, and RH shown in the drawings which will be referenced in the following explanation represent a forward direction (a travel direction), an upward direction, and a right hand direction of a vehicle, respectively. Further, directions opposite to those indicated by the arrows FR, UP, and RH represent a rearward direction, a downward direction, and a left hand direction of the vehicle, respectively. Hereinafter, unless otherwise specified, descriptions simply using terms of forward, rearward, right, left, upward, downward, and the like will denote forward or rearward in a vehicle longitudinal direction, right or left in a vehicle lateral direction (vehicle width direction), and upward or downward in a vehicle vertical direction.

FIG. 1 is a side view of the adjustable rear spoiler 10 in the embodiment. As shown in FIGS. 1, the adjustable rear spoiler 10 has a main wing 1 and a rear wing 2 that extend in the vehicle width direction above the vehicle body at the rear of the vehicle. The adjustable rear spoiler 10 also has a support plate 3 that supports the rear wing 2 so that it can rotate around a rotation axis 21 that extends in the vehicle width direction. The support plate 3 is arranged on both sides of the main wing 1 and the rear wing 2 in the vehicle width direction. Furthermore, the adjustable rear spoiler 10 has a central support plate 4 that extends in the vertical and longitudinal directions. The upper end of the central support plate 4 is fixed to the main wing 1, and the lower end is fixed to the vehicle body. Both ends of the main wing 1 in the vehicle width direction are fixed to the support plate 3. The main wing 1 is supported by the support plates 3 on both sides and the central support plate 4.

The adjustable rear spoiler 10 has a tubular support 5 extending downward from the support plate 3 on both sides of the vehicle width. The tubular support 5 is composed of a tubular support main body 51 and a tubular support cover 52. The adjustable rear spoiler 10 has one electric motor 6 and one base plate 61 on each side. The base plate 61 is fixed to the inside of the tubular support 5 in the vehicle width direction, and the electric motor 6 is fixed to the inside of the tubular support 5 in the vehicle width direction via the base plate 61.

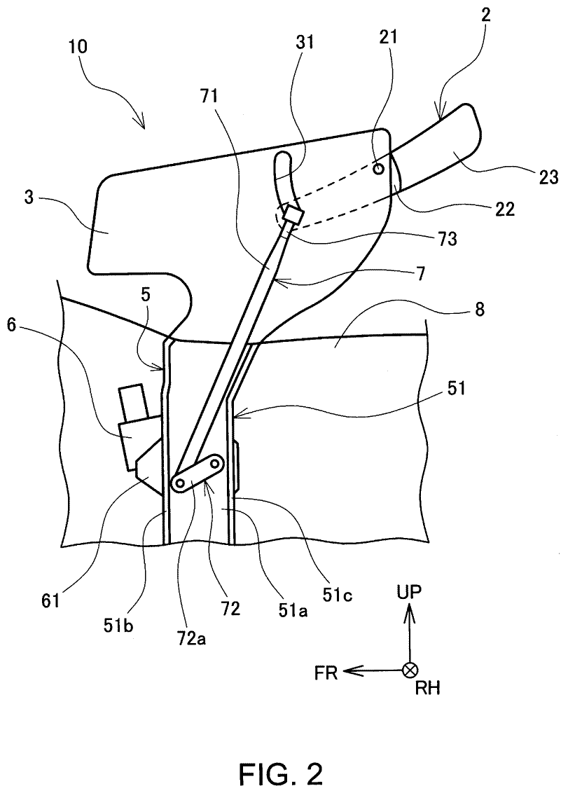

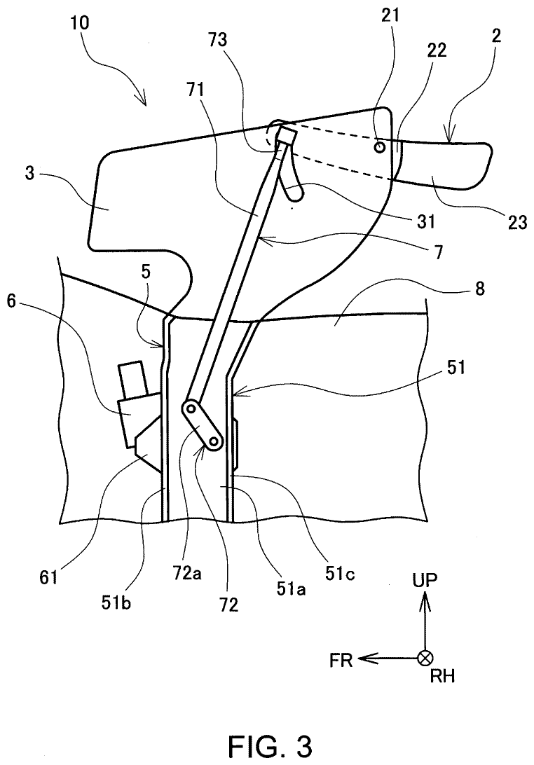

The adjustable rear spoiler 10 is equipped with a link mechanism 7 for rotating the rear wing 2 around a rotation axis 21. FIG. 2 is a side view showing the front part of the rear wing 2 lowered by the link mechanism 7. FIG. 3 is a side view showing the front part of the rear wing 2 raised by the link mechanism 7. FIGS. 2 and 3 both show the left-hand support plate 3 and the tubular support 5 viewed from the left. As shown in FIGS. 2 and 3, the link mechanism 7 comprises a link 71 that extends in the vertical direction and connects to the vehicle width-direction end of the rear wing 2 at the top, and a lifting mechanism 72 that raises and lowers the link 71 in the vertical direction by rotating the rotor of the electric motor 6.

The upper end of Link 71 is rotatably connected to the end surface 22 of the rear wing 2 in the vehicle width direction via a screw-in socket 73. The rotation axis 21 of the rear wing 2 is located at the rear of the vehicle width direction end surface 22 of the rear wing 2. The vehicle width direction center 23 of the rear wing 2 protrudes behind the rear end of the support plate 3. The support plate 3 has an arc-shaped through hole 31 for the part where the socket 73 connects to the vehicle width direction end surface 22 of the rear wing 2.

The lifting mechanism 72 includes the lever 72a, as well as the pinion 72b and the driven gear 72c, which will be described later, but the pinion 72b and the driven gear 72c are omitted in FIGS. 2 and 3. The adjustable rear spoiler 10 can be raised and lowered by rotating the lever 72a with the electric motor 6, which raises and lowers the link 71. The adjustable rear spoiler 10 can be rotated around the rotation axis 21 by raising and lowering the link 71 in this way, as the socket 73 connected to the vehicle width direction end surface 22 of the rear wing 2 moves up and down along the arc-shaped through hole 31.

The main body of the tubular support main body 51 is composed of an inner plate 51a that extends in the front-to-back direction on the inside of the vehicle width direction, a front plate 51b that extends from the front end of the inner plate 51a to the outside of the vehicle width direction, and a rear plate 51c that extends from the rear end of the inner plate 51a to the outside of the vehicle width direction. The support plate 3 extends upwards from the inner plate 51a. As shown in FIG. 1, the tubular support 5 has a square tube shape, with the tubular support cover 52 of approximately flat plate shape fixed to the outside of the tubular support main body 51. The lifting mechanism 72 is arranged inside the tubular support 5. In FIGS. 2 and 3, the tubular support cover 52 is omitted to show the link 71 and the lever 72a.

As shown in FIGS. 2 and 3, the support plate 3 is located outside the vehicle body 8, and the tubular support 5 is located inside the vehicle body 8. The electric motor 6 fixed to the tubular support 5 and the lifting mechanism 72 located inside the tubular support 5 are both located inside the vehicle body 8. Furthermore, the support plate cover, which covers the outside of the vehicle width direction and is not shown, is fixed to the support plate 3, so when the support plate cover is fixed to the support plate 3, the link 71 and socket 73 are not exposed.

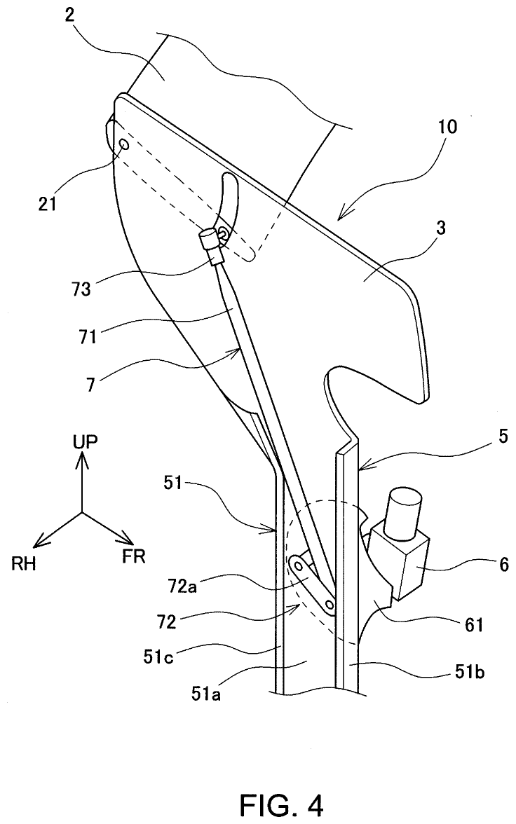

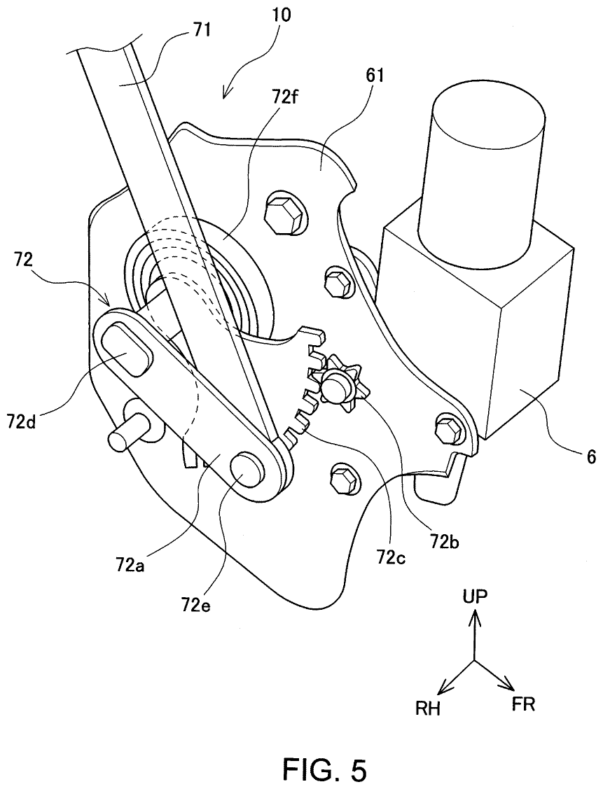

FIG. 4 is a perspective view showing the right-hand side link mechanism 7. FIG. 4 shows the front of the rear wing 2 lowered by the link mechanism 7. FIG. 4 shows the state where the front of the rear wing 2 is lowered by the link mechanism 7. FIG. 4 also omits the description of main wing 1. FIG. 5 is an oblique view showing an enlarged view of the lifting mechanism 72 of the link mechanism 7 shown in FIG. 4. FIG. 5 shows the state before the base plate 61 is fixed to the tubular support 5. As shown in FIG. 5, the electric motor 6 is fixed to one side of the base plate 61, and the lifting mechanism 72 is attached to the other side.

The lifting mechanism 72 comprises a lever 72a, a pinion 72b, a driven gear 72c, a shaft 72d, a link rotation shaft 72e, and a helical spring 72f. The pinion 72b is connected to the rotor of the electric motor 6 and rotates together with the rotor of the electric motor 6. The pinion 72b and the driven gear 72c constitute a gear pair that meshes with each other. Therefore, when the rotor of the electric motor 6 rotates, the driven gear 72c rotates around the shaft 72d as its axis of rotation. The shaft 72d is fixed to the driven gear 72c and the lever 72a. Therefore, the lever 72a rotates around the shaft 72d as its axis of rotation, together with the driven gear 72c. And because the lever 72a is connected to the link 71 in a way that allows it to rotate via the link rotation shaft 72e, the link 71 rises and falls up and down as the lever 72a rotates. Because the lifting mechanism 72 has this kind of structure, the adjustable rear spoiler 10 can rotate the rear wing 2 by raising and lowering the link 71 by rotating the rotor of the electric motor 6.

The helical spring 72f is wound around the shaft 72d in a spiral shape, and is a biasing element that exerts a force in the direction of pushing the link 71 upwards. As the helical spring 72f exerts a force in the direction of pushing the link 71 upwards, the adjustable rear spoiler 10 can suppress the rear wing 2 from swinging up and down due to the effect of the running wind during vehicle travel. In addition, the helical spring 72f may not be a spring component that exerts a force in the direction of pushing the link 71 upwards, but may be a spring component that exerts a force in the direction of pulling the link 71 downwards. Even when the helical spring 72f is a biasing element that exerts a force in the direction of pulling the link 71 downwards, the adjustable rear spoiler 10 can suppress the rear wing 2 from swaying up and down due to the effect of the running wind during vehicle travel.

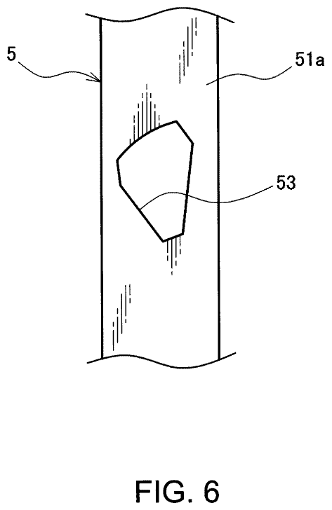

When fixing the base plate 61 to the tubular support 5, a through-hole 53 is required to allow the lifting mechanism 72 to be inserted into the tubular support 5. FIG. 6 shows the shape of the through-hole 53 formed in the inner plate 51a of the main body of the tubular support main body 51. When the base plate 61, to which the lifting mechanism 72 is attached, is fixed to the tubular support 5, the base plate 61 blocks the through-hole 53 and reinforces the tubular support 5. In this way, the adjustable rear spoiler 10 can improve the strength of the tubular support 5, which has a through-hole 53 formed in it, because the base plate 61 is fixed to the tubular support 5 to block the through-hole 53 and reinforce the tubular support 5.

In addition, the screw-in socket 73 can be moved up and down by manually rotating it. By adjusting the vertical position of the adjustable rear spoiler 10 in this way by rotating the socket 73, it is possible to reduce the vertical misalignment of the rear wing 2 caused by variations in the link mechanism 7. For example, if the height of the front edge of the rear wing 2 differs on the left and right due to variations in the left and right link mechanisms 7, it is possible to adjust the height of the front edge of the rear wing 2 on the left and right so that they are the same by rotating the socket 73.

As already mentioned, the electric motor 6 and the lifting mechanism 72 are mounted in the vehicle body 8. Therefore, the adjustable rear spoiler 10 can lower the vehicle's center of gravity and improve the CD value compared to a variable rear spoiler in which the electric motor 6 and the lifting mechanism 72 are arranged near the rear wing 2. In this way, the adjustable rear spoiler 10 can lower the vehicle's center of gravity and improve the CD value.

### SUPPLEMENTAL INFORMATION OF EMBODIMENT

The adjustable rear spoiler in this disclosure is not limited to the above-described embodiments, and may be implemented in various forms within the scope of the gist of this disclosure. For example, it may be a form that does not have a main wing 1 or a central support plate 4.

### Structure of the Invention

### Structure 1

1. A adjustable rear spoiler, comprising:
   a rear wing which extends above a vehicle body along a vehicle width direction;
   a support plate disposed at both ends of the rear wing to support the rear wing such that the rear wing is rotatable about a rotation axis that extends in the vehicle width direction:
   an electric motor disposed below each of the support plates; and
   a link mechanism disposed at both ends of the rear wing, each link mechanism comprising:
      a link extending in a vertical direction, an upper end of the link connected to an end of the rear wing; and
      a lifting mechanism which moves the link up and down by rotating a rotor of the electric motor,
   wherein the link mechanism allows the rear wing to be rotated about the rotation axis by moving the link up and down by rotating the rotor, and
   wherein the electric motors and the lifting mechanisms are arranged inside the vehicle body.

### Structure 2

2. The adjustable rear spoiler according to structure 1, further comprising:
   a tubular support which extends downward from each of the support plates; and
   a base plate attached to each of the tubular supports, the electric motor fixed on one surface of the base plate and the lifting mechanism attached to the other surface,
   wherein the tubular support has a through hole which allows the lifting mechanism to be inserted into the tubular support; and
   the electric motor is fixed on an outer side of the tubular support by fixing the base plate to the tubular support with the lifting mechanism having been inserted into the tubular support through the through hole such that the base plate blocks the through hole and reinforces the tubular support.

### Structure 3

3. The adjustable rear spoiler according to structure 1 or 2, wherein:
   the upper end of the link is connected to the end of the rear wing via a socket of a screw-in type; and
   the socket can be moved upward and downward by rotating the socket.

### Structure 4

4. The adjustable rear spoiler according to any one of structures 1 to 3, further comprising a biasing element which exerts a force in a direction of pushing the link upward or pulling the link downward.

1. An adjustable rear spoiler, comprising:
a rear wing which extends above a vehicle body along a vehicle width direction;
a support plate disposed at both ends of the rear wing to support the rear wing such that the rear wing is rotatable about a rotation axis that extends in the vehicle width direction:
an electric motor disposed below each of the support plates; and
a link mechanism disposed at both ends of the rear wing, each link mechanism comprising:
a link extending in a vertical direction, an upper end of the link connected to an end of the rear wing; and
a lifting mechanism which moves the link up and down by rotating a rotor of the electric motor,
wherein the link mechanism allows the rear wing to be rotated about the rotation axis by moving the link up and down by rotating the rotor, and
wherein the electric motors and the lifting mechanisms are arranged inside the vehicle body.

2. The adjustable rear spoiler according to claim 1, further comprising:
a tubular support which extends downward from each of the support plates; and
a base plate attached to each of the tubular supports, the electric motor fixed on one surface of the base plate and the lifting mechanism attached to the other surface,
wherein the tubular support has a through hole which allows the lifting mechanism to be inserted into the tubular support; and
the electric motor is fixed on an outer side of the tubular support by fixing the base plate to the tubular support with the lifting mechanism having been inserted into the tubular support through the through hole such that the base plate blocks the through hole and reinforces the tubular support.

3. The adjustable rear spoiler according to claim 1, wherein:
the upper end of the link is connected to the end of the rear wing via a socket of a screw-in type; and
the socket can be moved upward and downward by rotating the socket.

4. The adjustable rear spoiler according to claim 2, wherein:
the upper end of the link is connected to the end of the rear wing via a socket of a screw-in type; and
the socket can be moved upward and downward by rotating the socket.

5. The adjustable rear spoiler according to claim 3, further comprising a biasing element which exerts a force in a direction of pushing the link upward or pulling the link downward.

6. The adjustable rear spoiler according to claim 4, further comprising a biasing element which exerts a force in a direction of pushing the link upward or pulling the link downward.
